(19) United States
(12) Patent Application Publication
(10) Pub. No.: US 2024/0005152 A1
(43) Pub. Date: Jan. 4, 2024

(54) PASSIVE READOUT

(71) Applicant: AUTOBRAINS TECHNOLOGIES LTD, Tel Aviv-Yafo (IL)

(72) Inventors: Igal Raichelgauz, Tel Aviv (IL); Nitzan DAHAN, Tel Aviv (IL); Lior BLECH, TEL AVIV (IL)

(73) Assignee: AUTOBRAINS TECHNOLOGIES LTD, Tel Aviv-Yafo (IL)

(21) Appl. No.: 18/327,865

(22) Filed: Jun. 1, 2023

Related U.S. Application Data
(60) Provisional application No. 63/365,706, filed on Jun. 1, 2022.

(51) Int. Cl. G06N 3/08

(52) U.S. Cl. CPC G06N 3/08

(57) ABSTRACT

A method for passive readout, the method may include (i) obtaining a group of descriptors that were outputted by of one or more neural network layers; wherein descriptors of the group of descriptors comprise a first number (N1) of descriptor elements; and (ii) generating a lossless and sparse representation of the group of descriptors. The generating may include (a) applying a dimension expanding convolution operation on the group of descriptors to provide a group of expanded descriptors; wherein expanded descriptors of the group of expanded descriptors comprises a second number (N2) of expanded descriptor elements, wherein N2 exceeds N1; and (b) quantizing the group of expanded descriptors to provide a group of binary descriptors that form a lossless and a sparse representation of the group of descriptors.

### BACKGROUND

Neural networks are a subset of machine learning algorithms, inspired by the structure of the human brain. The attracting descriptor of neural networks is their ability to represent a vast space of functions while being relatively simple to implement. A downside of neural networks is their typically black box nature, which leads to difficulties in developing interpretable and robust neural networks. One difference between the workings of neural networks and the brain is that neural network activations are relatively dense, whereas the brain activates very sparsely.

### SUMMARY

A method, system and non-transitory computer readable medium for passive readout.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a method;

FIG. 2 illustrates an example of a method; and

FIG. 3-4 illustrate examples of an training set-up.

### DESCRIPTION OF EXAMPLE EMBODIMENTS

The specification and/or drawings may refer to an image. An image is an example of a media unit. Any reference to an image may be applied mutatis mutandis to a media unit. A media unit may be an example of sensed information. Any reference to a media unit may be applied mutatis mutandis to a natural signal such as but not limited to signal generated by nature, signal representing human behavior, signal representing operations related to the stock market, a medical signal, and the like. Any reference to a media unit may be applied mutatis mutandis to sensed information. The sensed information may be sensed by any type of sensors—such as a visual light camera, or a sensor that may sense infrared, radar imagery, ultrasound, electro-optics, radiography, LIDAR (light detection and ranging), etc.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

Sparse Binary readouts is a building block inspired by the brain which increases the sparseness of the neural network by connecting to an existing network and converting the dense activations to a sparse representation. The sparse representations enable disentangling the original neural network descriptors into more interpretable and robust descriptors.

The sparse representation is better suited to apply either further neural network building blocks or classical algorithms, which improves the base network performance and robustness as well as improving interpretability.

In addition, due to its self-supervised nature, it enables applications such as
Providing context information absent in typical ground truth scenarios.
Enabling changing or adding labels post hoc.
Adding new functionality absent in the base network.

The suggested passive readout unit is designed to cast the compressed representation of the backbone into a sparse representation with no loss of information. In order to not lose information used for the original task the backbone was used for—the information bottleneck layer, typically the last backbone layer, is used as the input for the readout.

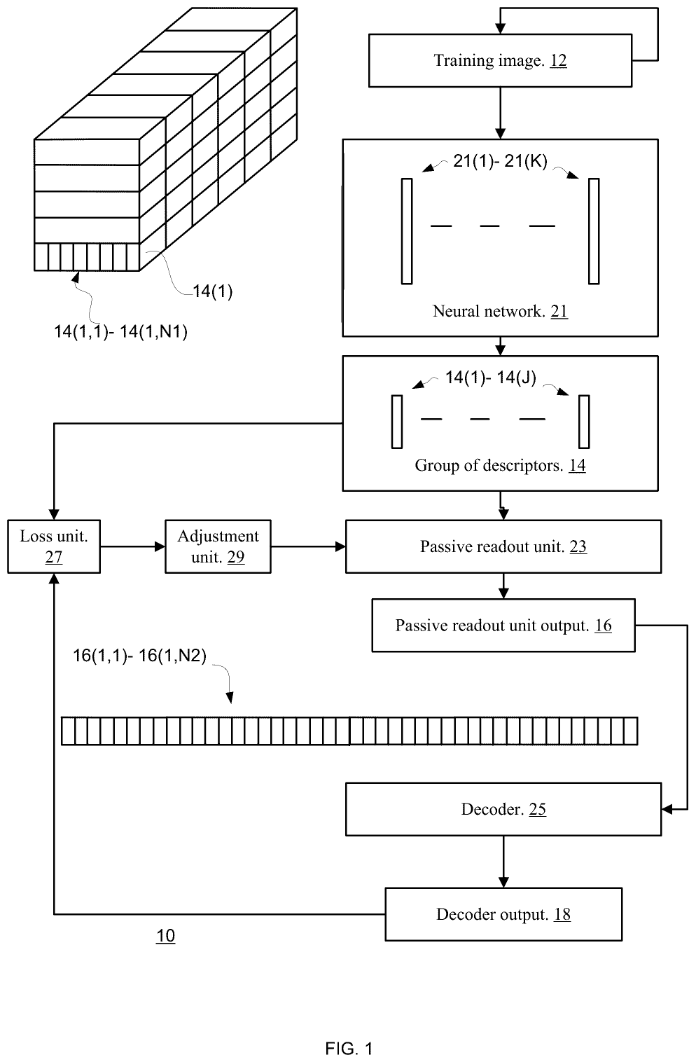

FIG. 1 illustrates an example of a basic framework 10 for training the passive readout unit 23. The training procedure may follow an autoencoder pattern with the optional addition of regularization losses similar to their use in sparse autoencoders. The autoencoder framework ensures the preservation of the information in the group of descriptors. The sparseness and decorrelation of the SBR emerges due to its large dimensionality.

For each training image 12 (out of multiple training images—see the arrow that connected between training images to itself—representing repetition over multiple training images):
Feeding the training image 12 to neural network 21 having K layers 21(1)-21(K), K being a positive integer.
Neural network 21 outputs a group of descriptors 14. The group of descriptors includes J descriptors 14(1)-14(J), J being a positive integer. The N1 elements 14(1,1)-14(N1) of descriptor 14(1) are shown.
The group of descriptors 14 are fed to passive readout unit 23.
The passive readout unit 23 outputs passive readout circuit output 16. The N2 elements 16(1,1)-16(N2) of binary descriptor 16(1) are shown.
The passive readout circuit output 16 is fed to the decoder 25.
The decoder outputs decoder output 18.
The decoder output 18 should be (ideally) equal to the group of descriptors 14.
A loss unit 27 receives the decoder output 18 and the group of descriptors 14 and applies a loss function—for example applies the loss function on the difference between the decoder output 18 and the group of descriptors 14 to provide a loss function output.
The loss function output is fed to adjustment unit 29 that adjusts the passive readout unit 23 in order to induce the passive readout unit 23 to output a passive readout unit output that is a lossless and sparse representation of the group of descriptors.

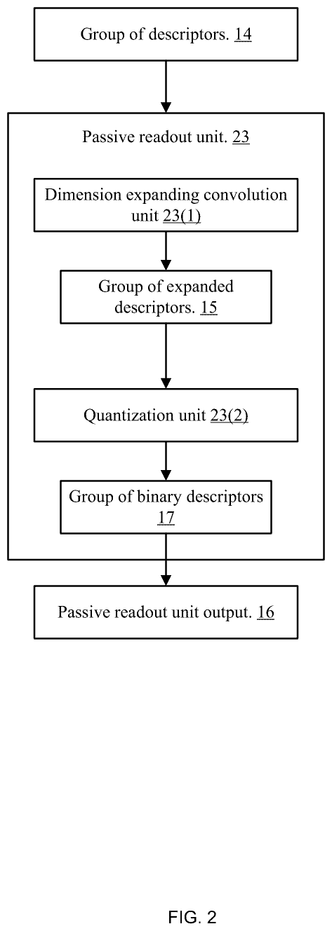

FIG. 2 illustrates an example of a passive readout unit. The passive readout unit may include a dimension expanding convolutional unit 23(1) which interprets each descriptor (also referred as a pixel or a keypoint) in the group of descriptors in isolation (from other descriptors) and may use shared weights for the computation. The dimension expanding convolutional unit 23(1) projects each descriptor to a higher dimension (for example by multiplying the descriptor by a high dimensional matrix) to provide a group of expanded descriptors 15. The group of expanded descriptors 15 quantized by quantization unit 23(2) to provide a group of binary descriptors 17 that form the passive readout unit output 16.

Examples of quantization schemes that can be applied by quantization unit may include thresholding, top-K quantization, argmax quantization, and the like. A gradient of the quantization unit may be computed by the so called straight through estimator [Bengio, Y., Leonard, N., and Courville, 2013] which may include pretending the quantization layer is an identity function during the backward propagation.

The decoder 25 may have a structure that is inverse to the structure of the passive readout unit. The decoder may use a convolutional architecture that decreases the number of dimensions back to the original dimensionality of the group of descriptors 14 inputted to the passive readout unit.

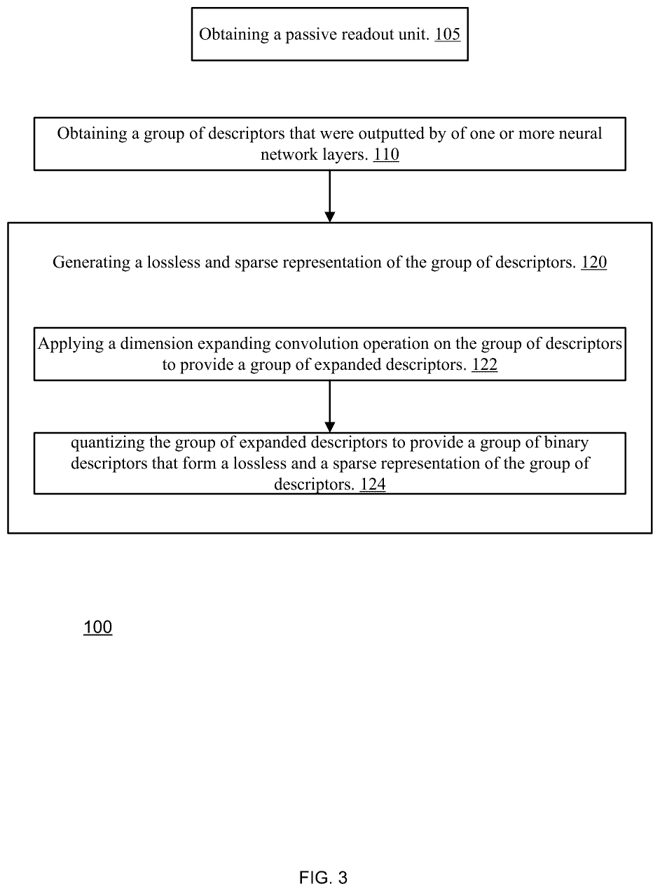

FIG. 3 illustrates method 100 for passive readout.

Method 100 may start by step 110 of obtaining a group of descriptors that were outputted by of one or more neural network layers. Descriptor of the group of descriptors includes a first number (N1) of descriptor elements. The N1 descriptor elements may belong to N1 different channels.

The group of descriptors may be outputted from a single layer—and may form a descriptor map. The group of descriptors may include two of more sub-group of descriptors that are outputted from two or more corresponding layers.

Step 110 may be followed by step 120 of generating a lossless and sparse representation of the group of descriptors.

Step 120 may include step 122 of applying a dimension expanding convolution operation on the group of descriptors to provide a group of expanded descriptors.

The expanded descriptors of the group of expanded descriptors includes a second number (N2) of expanded descriptor elements. N2 exceeds N1—for example by a factors of at least 5, 10, 20, 50, 100, 120, 150, 200, 250, 300, 350, 400, 500, 750, 1000, 1200, 1500, 1800, 2000, 3000, 4000 and even more.

Step 122 may be followed by step 124 of quantizing the group of expanded descriptors to provide a group of binary descriptors that form a lossless and a sparse representation of the group of descriptors.

Step 122 may include independently applying a dimension expanding convolution process on each descriptor of the group of descriptors.

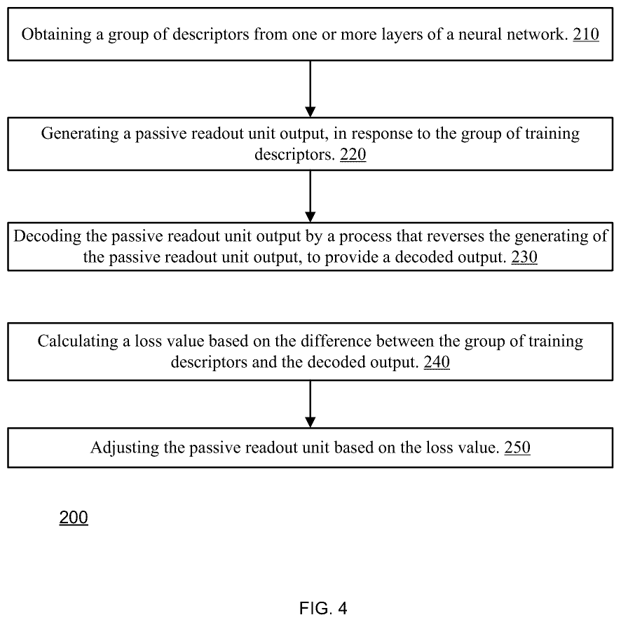

Step 120 may be executed by a passive readout unit that is trained by a training process. An example of a training process is illustrated in FIG. 4.

Method 100 may include step 105 of obtaining the passive readout unit. The obtaining may include the training process of the passive readout unit. Alternatively—the obtaining may include receiving a trained passive readout unit.

FIG. 4 illustrates an example of training process 200.

Training process 200 may be a repetitive method that includes multiple iterations.

An iteration may be executed per each training image of multiple training images.

Step 210 may include obtaining an output of a neural network, the output is related to a training image fed to the neural network. The output includes a group of descriptors from one or more layers of the neural network. Step 210 may include feeding the training image to a neural network, and outputting, by the neural network, a group of training descriptors related to the training image.

Step 210 may be followed by step 220 of generating a passive readout unit output, in response to the group of training descriptors. The passive readout unit output should be (at least at the end of the training) a lossless and a sparse representation of the group of descriptors.

Step 220 may be followed by step 230 of decoding the passive readout unit output by a process that reverses the generating of the passive readout unit output, to provide a decoded output.

Step 230 may be followed by step 240 of calculating a loss value based on the difference between the group of training descriptors and the decoded output.

Step 240 may be followed by step 250 of adjusting the passive readout unit based on the loss value.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system and any other component should be applied mutatis mutandis to a method that may be executed by a system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any combination of any module or unit listed in any of the figures, any part of the specification and/or any claims may be provided. Especially any combination of any claimed feature may be provided.

Any reference to the term “comprising” or “having” should be interpreted also as referring to “consisting” of “essentially consisting of”. For example—a method that comprises certain steps can include additional steps, can be limited to the certain steps or may include additional steps that do not materially affect the basic and novel characteristics of the method—respectively.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a computer program product such as non-transitory computer readable medium. All or some of the computer program may be provided on non-transitory computer readable media permanently, removably or remotely coupled to an information processing system. The non-transitory computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc. A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system. The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments. Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for passive readout, the method comprises:
obtaining a group of descriptors that were outputted by of one or more neural network layers; wherein descriptors of the group of descriptors comprise a first number (N1) of descriptor elements; and
generating a lossless and sparse representation of the group of descriptors, wherein the generating comprises:
applying a dimension expanding convolution operation on the group of descriptors to provide a group of expanded descriptors; wherein expanded descriptors of the group of expanded descriptors comprises a second number (N2) of expanded descriptor elements, wherein N2 exceeds N1; and
quantizing the group of expanded descriptors to provide a group of binary descriptors that form a lossless and a sparse representation of the group of descriptors.

2. The method according to claim 1 wherein the applying of the dimension expanding convolution operation comprises independently applying a dimension expanding convolution process on each descriptor of the group of descriptors.

3. The method according to claim 1 wherein the quantizing is a top-K quantization.

4. The method according to claim 1 wherein the quantizing is a argmax quantization.

5. The method according to claim 1 wherein N2 exceeds N1 by at least a factor of 10.

6. The method according to claim 1 wherein N2 exceeds N1 by at least a factor of 1000.

7. The method according to claim 1 wherein the generating is executed by a readout unit that is trained by a training process.

8. The method according to claim 7 wherein the training comprises:
repeating, for each training image of multiple training images:
outputting, by a neural network, a group of training descriptors related to the training image;
generating a passive readout unit output, in response to the group of training descriptors;
decoding the passive readout unit output by a process that reverses the generating of the passive readout unit output, to provide a decoded output; and
adjusting the passive readout unit based on a difference between the group of training descriptors and the decoded output.

9. The method according to claim 7 comprising training the passive readout circuit by the training circuit.

10. The method according to claim 9 wherein the training comprises:
repeating, for each training image of multiple training images:
outputting, by a neural network, a group of training descriptors related to the training image;
generating a passive readout unit output, in response to the group of training descriptors;
decoding the passive readout unit output by a process that reverses the generating of the passive readout unit output, to provide a decoded output; and
adjusting the passive readout unit based on a difference between the group of training descriptors and the decoded output.

11. A non-transitory computer readable medium for passive readout, the non-transitory computer readable medium that stores instructions for:
obtaining a group of descriptors that were outputted by of one or more neural network layers; wherein descriptors of the group of descriptors comprise a first number (N1) of descriptor elements; and
generating a lossless and sparse representation of the group of descriptors, wherein the generating comprises:
applying a dimension expanding convolution operation on the group of descriptors to provide a group of expanded descriptors; wherein expanded descriptors of the group of expanded descriptors comprises a second number (N2) of expanded descriptor elements, wherein N2 exceeds N1; and
quantizing the group of expanded descriptors to provide a group of binary descriptors that form a lossless and a sparse representation of the group of descriptors.

12. The non-transitory computer readable medium according to claim 11 wherein the applying of the dimension expanding convolution operation comprises independently applying a dimension expanding convolution process on each descriptor of the group of descriptors.

13. The non-transitory computer readable medium according to claim 11 wherein the quantizing is a top-K quantization.

14. The non-transitory computer readable medium according to claim 11 wherein the quantizing is a argmax quantization.

15. The non-transitory computer readable medium according to claim 1 wherein N2 exceeds N1 by at least a factor of 10.

16. The non-transitory computer readable medium according to claim 11 wherein N2 exceeds N1 by at least a factor of 1000.

17. The non-transitory computer readable medium according to claim 11 wherein the generating is executed by a passive readout unit that is trained by a training process.

18. The non-transitory computer readable medium according to claim 17 wherein the training comprises:
repeating, for each training image of multiple training images:
outputting, by a neural network, a group of training descriptors related to the training image;
generating a passive readout unit output, in response to the group of training descriptors;
decoding the passive readout unit output by a process that reverses the generating of the passive readout unit output, to provide a decoded output; and
adjusting the passive readout unit based on a difference between the group of training descriptors and the decoded output.

19. The non-transitory computer readable medium according to claim 17 that stores instructions for training the readout circuit by the training circuit.

20. The non-transitory computer readable medium according to claim 19 wherein the training comprises:
repeating, for each training image of multiple training images:
outputting, by a neural network, a group of training descriptors related to the training image;
generating a passive readout unit output, in response to the group of training descriptors;
decoding the passive readout unit output by a process that reverses the generating of the passive readout unit output, to provide a decoded output; and
adjusting the passive readout unit based on a difference between the group of training descriptors and the decoded output.
